(19) United States
(12) Patent Application Publication
(10) Pub. No.: US 2013/0227328 A1
(43) Pub. Date: Aug. 29, 2013

(54) MASSIVELY PARALLEL COMPUTER, AND METHOD AND PROGRAM FOR SYNCHRONIZATION THEREOF

(71) Applicant: NEC Corporation, (US)

(72) Inventor: Yasuo ISHII, Tokyo (JP)

(73) Assignee: NEC CORPORATION, Tokyo (JP)

(21) Appl. No.: 13/775,356

(22) Filed: Feb. 25, 2013

(30) Foreign Application Priority Data
Feb. 23, 2012 (JP) 2012-037566

(51) Int. Cl. G06F 1/12

(52) U.S. Cl. CPC G06F 1/12
USPC 713/375

(57) ABSTRACT

The a massively parallel computer including a plurality of CPUs to implement barrier synchronization by using a global barrier synchronous counter, wherein the CPUs each comprises a computation core including a GBF cache which caches a part of a plurality of global barrier synchronous flags for controlling synchronization between the CPUs, and a communication control unit including the global barrier synchronous flag, when making a request for reference to the global barrier synchronous flag, the computation core first referring to the GBF cache and only when the reference has a cache miss, making a request to the communication control unit to refer to the global barrier synchronous flag.

### TECHNICAL FIELD

The present invention relates to a massively parallel computer which implements barrier synchronization by using a global barrier synchronous counter and, more particularly, a technique for reducing barrier synchronization variation time.

### BACKGROUND ART

Computation core checks a global barrier synchronous flag (GBF) by issuing a request for reference to a global barrier synchronous flag to a communication control unit.

Assume here that the upper limit of the number of references in process of a GBF reference request is 1. Assuming latency of GBF reference to be 50 ns, the worst case will obtain a GBF reference result approximately 50 ns later than in the best case.

Moreover, when the reference competes with a reference request from other computation core, it is a common practice that an interval of the reference might vary due to arbitration of requests and in the worst case, increased latency will be required.

With a communication control unit being capable of processing one request per 1.66 ns, when four computation cores issue a GBF reference request simultaneously, for example, the least fortunate computation core 110 will require additional latency of 5 ns. Its numerical value will be increased as the number of computation cores which refer to one communication control unit increases.

Furthermore, in a synchronization mechanism on a massively parallel computer, computation cores on more than 1000 CPUs refer to GBFs on communication control units. On this occasion, it is very rare that such unfortunate case as described above fails to occur in every computation core and it is highly probable that the above-described worst case occurs in any process.

Refer here to FIG. 17 which shows a case where the above-described two worst values occur simultaneously. While a computation core 2 completes at the best timing, a computation core 0 completes at the worst timing. Since end time of an application is defined by the latest process, completion of processing A in all the computation cores lags by 55 ns behind that of the processing in a case of the best value.

As related art here, invention aiming at relieving synchronization overhead by relieving false share is disclosed in Patent Literature 1. The invention disclosed in Patent Literature 1 notifies participation in/completion of synchronization by a broadcast based method.

Another related art is the invention disclosed in Patent Literature 2 which relates to sharing of a memory address space through interconnection between nodes.

Further related art is the invention disclosed in Patent Literature 3 which realizes high-speed synchronous processing in a node by using an updating cache and counter subtraction.

Patent Literature 1: Japanese Patent Laying-Open No. 2002-007371

Patent Literature 2: Japanese Patent Laying-Open No. 2002-304328

Patent Literature 3: Japanese Patent Laying-Open No. 06-149752

Patent Literature 4: U.S. Patent Publication No. 2011/0173413

Synchronization control mechanism using GBC (Global Barrier Synchronous Counter) or GBF according to the background art has the following problems.

First problem is that because a communication control unit reference time is long, checking of global barrier synchronous flag update lags as compared with other computation core depending on reference start timing.

Second problem is that because a communication control unit is shared by a plurality of computation cores, checking of update might further lag behind due to arbitration control timing.

Third problem is that cases close to the worst which can be presumed in the above-described two problems occur on a daily basis in barrier synchronization of a massively parallel computer including more than 1000 CPUs.

The invention disclosed in Patent Literature 1, here aiming at relieving synchronization overhead, includes more than 1000 computation nodes in the system for constantly informing all the CPUs of participation in/establishment of synchronization and is not allowed to have the same function of GBC/GBCF system in which a part of processors synchronize with each other. In addition, since the invention disclosed in Patent Literature 1 employs a system based on invalidation by a cache consistency protocol, its performance is lower than that of the proposed method using updating cache.

The invention disclosed in Patent Literature 2, which realizes high-speed synchronous processing in a node by using an updating cache and counter subtraction, is not allowed to locate a cache on a communication pathway. In addition, unless synchronization is implemented after reinitialization of a counter after first synchronization is established, data as of after the initialization will be seen differently in each process, so that Partial Store Ordering cannot be realized.

While the invention disclosed in Patent Literature 2 includes a cache filter for managing coherence traffic, cache systems realized by Patent Literature 1, 2 and 3 enable only (1) synchronization control by broadcasting, (2) reduction in traffic by a cache filter and (3) notification of synchronization establishment using an updating cache, and disable realization of Partial Store Ordering.

### OBJECT OF THE INVENTION

An object of the present invention is to provide a massively parallel computer, and a method and a program for synchronization thereof which solve the above-described problems and reduce global barrier synchronous flag reference time to realize a stable global barrier synchronization mechanism.

### SUMMARY

According to an exemplary aspect of the invention, a massively parallel computer including a plurality of CPUs to implement barrier synchronization by using a global barrier synchronous counter, wherein the CPUs each comprises

a computation core including a GBF cache which caches a part of a plurality of global barrier synchronous flags for controlling synchronization between the CPUs, and

a communication control unit including the global barrier synchronous flag,

when making a request for reference to the global barrier synchronous flag, the computation core first referring to the GBF cache and only when the reference has a cache miss, making a request to the communication control unit to refer to the global barrier synchronous flag.

According to an exemplary aspect of the invention, a synchronization method by a massively parallel computer including a plurality of CPUs to implement barrier synchronization by using a global barrier synchronous counter, which CPUs each including a computation core and a communication control unit, wherein

when making a request to the communication control unit including a global barrier synchronous flag for reference to the global barrier synchronous flag, the computation core executes a step of first referring to a GBF cache that the computation core includes and only when the reference has a cache miss, making a request to the communication control unit to refer to the global barrier synchronous flag, and

the GBF cache caches a part of a plurality of global barrier synchronous flags for controlling synchronization between the CPUs.

According to an exemplary aspect of the invention, a computer-readable medium storing a synchronization program operable on a computer forming a massively parallel computer including a plurality of CPUs to implement barrier synchronization by using a global barrier synchronous counter, the CPUs each including a computation core and a communication control unit, wherein the synchronization program executes the following processing of:

causing the computation core to execute a processing of, when making a request to the communication control unit including a global barrier synchronous flag for reference to the global barrier synchronous flag, first referring to the GBF cache that the computation core includes and only when the reference has a cache miss, making a request to the communication control unit to refer to the global barrier synchronous flag; and

caching a part of a plurality of global barrier synchronous flags for controlling synchronization between the CPUs to a GBF cache that the computation core has.

The present invention realizes a stable global barrier synchronization mechanism by caching a global barrier synchronous flag in a computation core to reduce global barrier synchronous flag reference time.

Other objects, features and advantages of the present invention will become clear from the detailed description given herebelow.

### BRIEF DESCRIPTION OF THE DRAWINGS

In the drawings:

FIG. 1 is a block diagram showing a structure of a massively parallel computer related to a synchronization system on which the present invention is premised;

FIG. 2 is a diagram showing operation of GBC, GBCI and GBF related to a synchronization system on which the present invention is premised;

FIG. 3 is a diagram showing operation to be executed when using GBC related to the synchronization system on which the present invention is premised;

FIG. 4 is a block diagram showing a structure of a massively parallel computer according to a first exemplary embodiment of the present invention;

FIG. 5 is a diagram showing an example of a structure of a GBF cache according to the first exemplary embodiment of the present invention;

FIG. 6 is a diagram showing an example of a structure of a GBF cache filter according to the first exemplary embodiment of the present invention;

FIG. 7 is a diagram showing outlines of operation executed at the time of establishment of synchronization according to the first exemplary embodiment of the present invention;

FIG. 8 is a diagram showing processing of a GBF reference request by a computation core according to the first exemplary embodiment of the present invention;

FIG. 9 is a diagram showing entry registration of the GBF cache according to the first exemplary embodiment of the present invention;

FIG. 10 is a block diagram showing a structure of a massively parallel computer according to a second exemplary embodiment of the present invention;

FIG. 11 is a block diagram showing a structure of a massively parallel computer according to a third exemplary embodiment of the present invention;

FIG. 12 is a diagram showing an example of a structure of a GBF cache filter according to the third exemplary embodiment of the present invention;

FIG. 13 is a block diagram showing a structure of a massively parallel computer according to a fourth exemplary embodiment of the present invention;

FIG. 14 is a diagram showing an example of arrangement of a GBC ID according to the fourth exemplary embodiment;

FIG. 15 is a diagram showing a synchronization control mechanism of the present invention;

FIG. 16 is a block diagram showing a minimum structure of the massively parallel computer of the present invention; and

FIG. 17 is a diagram showing a synchronization control mechanism according to background art.

### EXEMPLARY EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

In order to clarify the foregoing and other objects, features and advantages of the present invention, exemplary embodiments of the present invention will be detailed in the following with reference to the accompanying drawings. Other technical problems, means for solving the technical problems and functions and effects thereof other than the above-described objects of the present invention will become more apparent from the following disclosure of exemplary embodiments. In all the drawings, like components are identified by the same reference numerals to appropriately omit description thereof

### First Exemplary Embodiment

First exemplary embodiment of the present invention will be detailed with reference to the drawings.

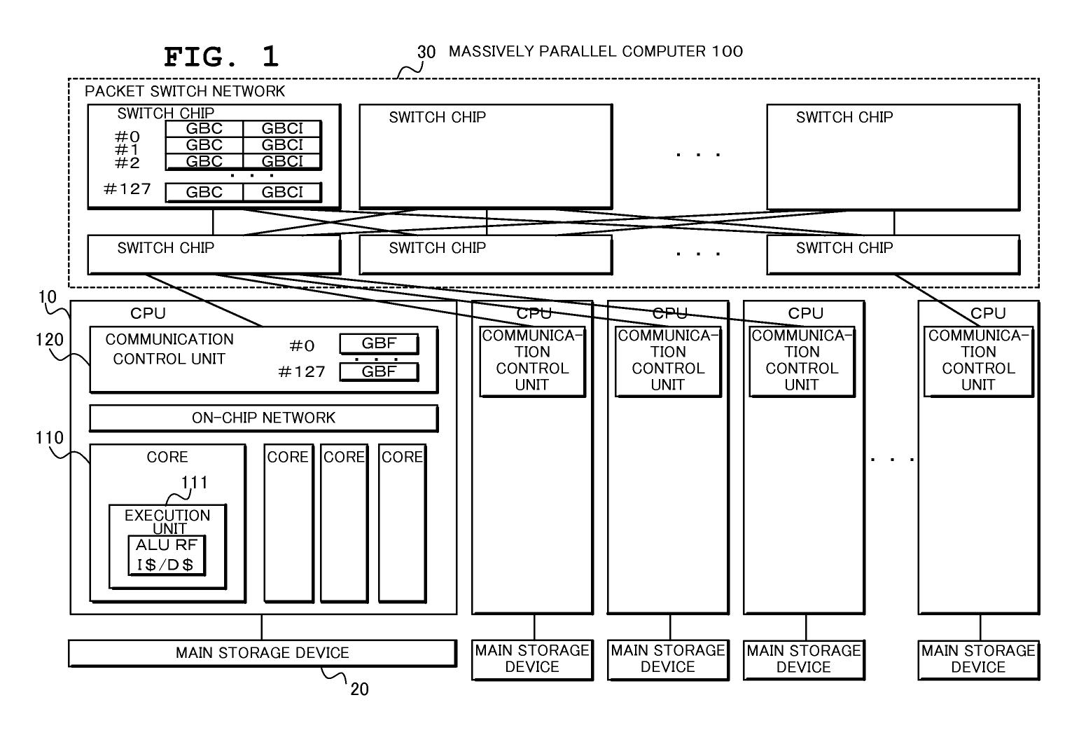

First, a synchronization system on which the present invention is premised will be described with reference to FIG. 1.

FIG. 1 is a block diagram showing a structure of a massively parallel computer 100 on which the present invention is premised. With reference to FIG. 1, the massively parallel computer 100 includes a plurality of CPUs 10, a main storage device 20 and a packet switch network 30.

The CPU 10 executes program processing. The CPUs 10, which exist in numbers (e.g. more than 1000) in the massively parallel computer 100, execute a program while communicating with each other. Each CPU 10 separately has the main storage device 20 such as a main memory.

The CPU 10 includes a plurality of computation cores 110 and a communication control unit 120.

The computation core 110 is a unit which executes a program. The computation core 110 executes a program by using an execution unit 111 including ALU or a register file. The computation core 110 is capable of accessing the main storage device 20 connected to the CPU 10 to which the computation core 110 itself belongs. It is assumed that for identifying each computation core 110, the core may be hereafter denoted as a computation core 0, a computation core 1, or the like.

The communication control unit 120 is a unit which receives and controls a communication request from the computation core 110 in the massively parallel computer. The communication control unit 120 also receives and controls a communication request generated in the communication control unit 120 in other CPU 10 or the packet switch network 30.

The request received by the communication control unit 120 is processed based on the contents of the request. Executed, for example, are injecting into the packet switch network 30 the data on the main storage device 20 connected to the CPU 10 to which the communication control unit 120 belongs and writing the data received from the packet switch network 30 to the main storage device 20.

The communication control unit 120 also has a global barrier synchronous flag (GBF) for executing synchronization control between CPUs.

In each communication control unit 120, GBF are held as many as the number of GBCs in the system. If 128 GBCs exist, for example, 128 GBFs will exist in each communication control unit 120 of each CPU 10. GBF is defined as data coherent in the CPU 10. More specifically, a value and a change order of GBF seen from all the computation cores 110 in the CPU 10 should be unique.

For example, as to GBF whose original value is X, when the computation core 0 rewrites the GBF to Y and at the same time a computation core 1 rewrites the GBF to Z, and a computation core 2 rewrites the GBF to W immediately thereafter, if the computation cores 0, 1 and 2 read the GBF, all the computation cores 110 should see the change being executed in the order of X→Y→Z→W. Alternatively, all the computation cores 110 should see the change being executed in the order of X→Z→Y→W.

When referring to the related entry immediately after the computation core 110 issues a write instruction, data as of after write should be read. When the value changes in the order of X→Y→Z→W in the above-described example, after the computation core 2 issues a write instruction, Z or W should be read and Y should not be read. The consistency model is called Partial Store Ordering which is common to those skilled in the art.

The packet switch network 30 transfers a communication packet injected from the communication control unit 120 of each CPU 10 to appropriate CPU 10 or resources in a network. Although shown in FIG. 1 is the packet switch network 30 having a Fat-tree topology, the network is not limited to such topology but may take other network configuration such as a three-dimensional torus configuration.

As network resources, the network has a global barrier synchronous counter (GBC) for controlling synchronization between CPUs and a global barrier synchronous counter for initial value (GBCI) indicative of its initial value.

GBC and GBCI exist in the packet switch network. GBC and GBCI are one-to-one paired, to which a unique ID is assigned.

It is assumed in the present exemplary embodiment that 128 pairs of GBC and GBCI exist on switch chip. The above-described “unique ID” will be hereafter denoted as “GBC ID” or simply as “ID”.

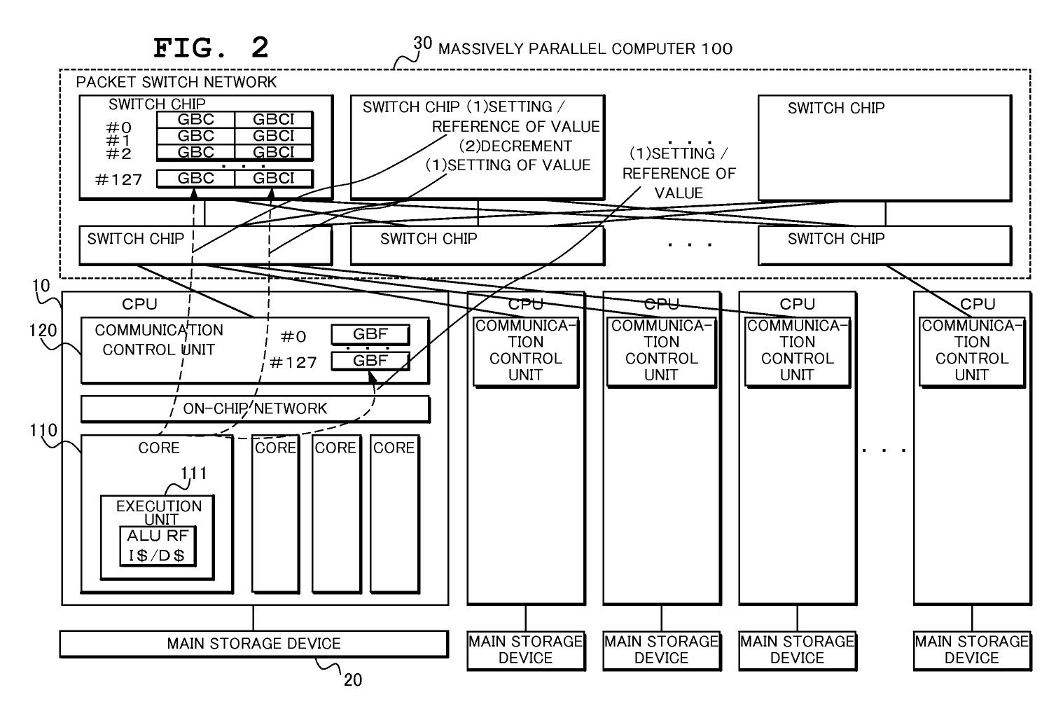

The following operation can be executed with respect to GBC, GBCI and GBF. The operation is shown in FIG. 2.

As GBCI, its value can be set by an instruction from the computation core 110.

With respect to GBC, (1) setting of a value and (2) decrement of a value can be executed by an instruction from the computation core 110. The operation can be realized by injecting a communication instruction from the computation core 110 into the packet switch network 30 through the communication control unit 120.

With respect to GBF, (1) setting of a value and (2) reference to a value can be executed by an instruction from the computation core 110. The above-described operation can be realized by receiving an instruction sent from the computation core 110 by the communication control unit 120 to execute the processing.

As described above, GBC, a counter which monitors establishment of synchronization, is decremented by an instruction from the computation core 110. With ID of GBC designated, the instruction from the computation core 110 is injected into the packet switch network 30 and routed to the relevant GBC to control GBC/GBCI.

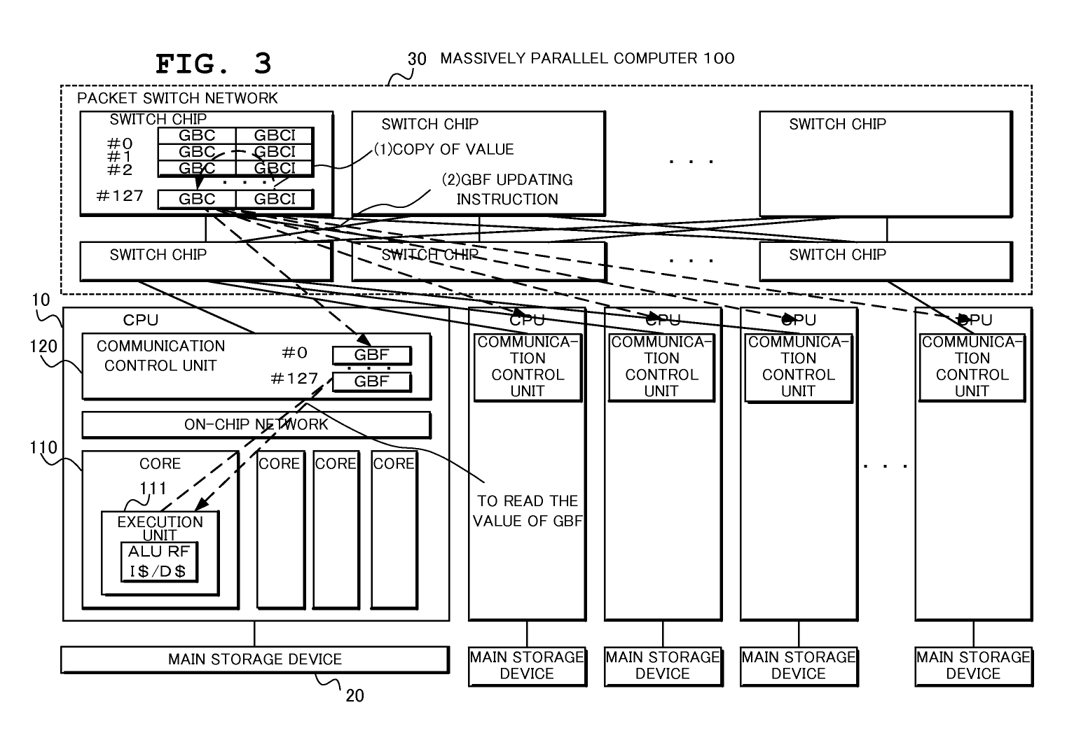

Operation to be executed when using GBC is shown in FIG. 3. GBC/GBCI is initialized by the number of processes to participate in synchronization and when entering a synchronization waiting state, each process sends a GBC decrement instruction only once.

When GBC attains 0 as a result of this operation, (1) the value of GBCI is copied on to GBC, (2) a synchronization establishment instruction is broadcast to the communication control unit 120 of each CPU 10 through the network. The communication control unit 120 updates the value of GBF when the synchronization establishment instruction arrives. Thereafter, (3) the computation core 110 is allowed to know the establishment of synchronization by reading the value of GBF.

Next, description will be made of a structure of the massively parallel computer 100 according to the first exemplary embodiment of the present invention.

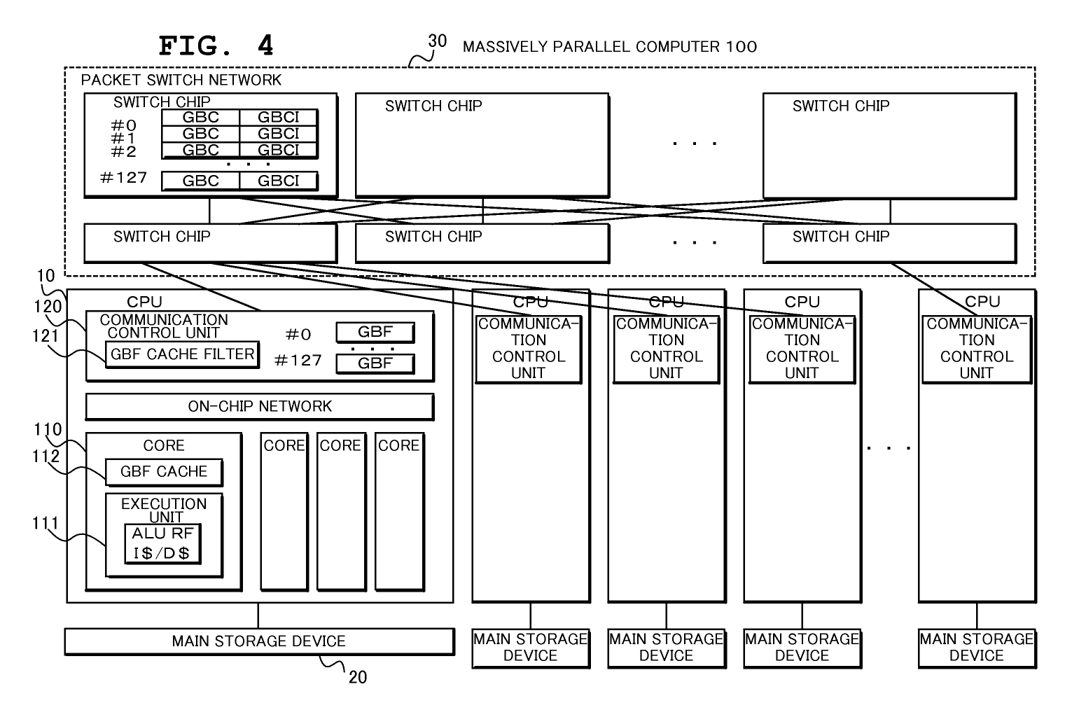

FIG. 4 is a block diagram showing a structure of a massively parallel computer 100 according to the present exemplary embodiment. The massively parallel computer 100 according to the present exemplary embodiment, as compared with the structure of the massively parallel computer 100 shown in FIG. 1, has a structure with (1) a GBF cache 112 provided on the computation core 110 and (2) a GBF cache filter 121 provided on the communication control unit 120, added.

In FIG. 4, the GBF cache 112 holds a copy of a part of GBFs on the communication control unit 120. While the present exemplary embodiment is premised on copies on the order of eight, it is not limited thereto.

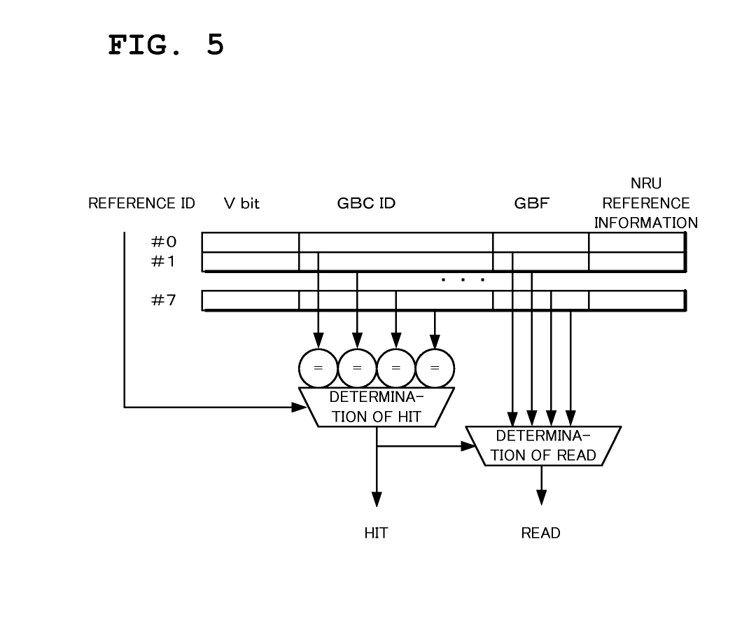

Example of a structure of the GBF cache 112 is shown in FIG. 5. The GBF cache 112 has a 1-bit valid bit, a GBC ID related to GBF to be cached, a GBF flag and reference information for replacement. While used as a replacement policy is Not Recently Used policy (NRU), other policies may be used such as LRU (Least Recently Used) or random policy.

In FIG. 4, the GBF cache filter 121 stores information about which computation core 110 holds the GBF cache 112 of which ID.

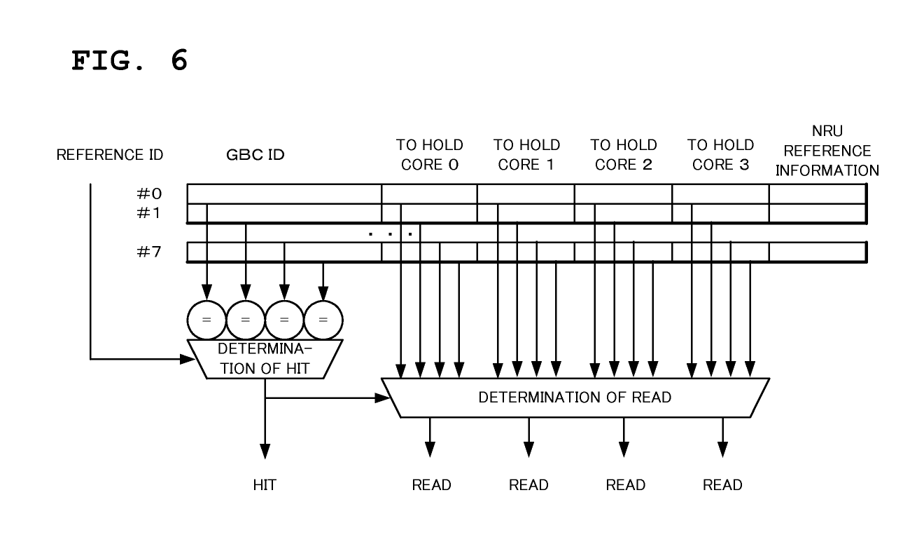

Structure of the GBF cache filter 121 is shown in FIG. 6. Each entry of the GBF cache filter 121 has a GBC ID related to GBF cached, the number of the computation core 110 held, and reference information for replacement. Entries as many as the total of the number of the computation cores 110 in the CPU 10 and the number of entries of the GBF cache 112 held by each computation core 110 are sufficient.

As well as the GBF cache 112, the GBF cache filter 121 controls replacement by NRU. Used as the replacement policy may be other policy such as LRU or random policy.

At the time of GBF reference, the computation core 110, which holds the GBF cache 112, refers first to the GBF cache 112 and only when no target data exists in the GBF cache 112, refers to GBF.

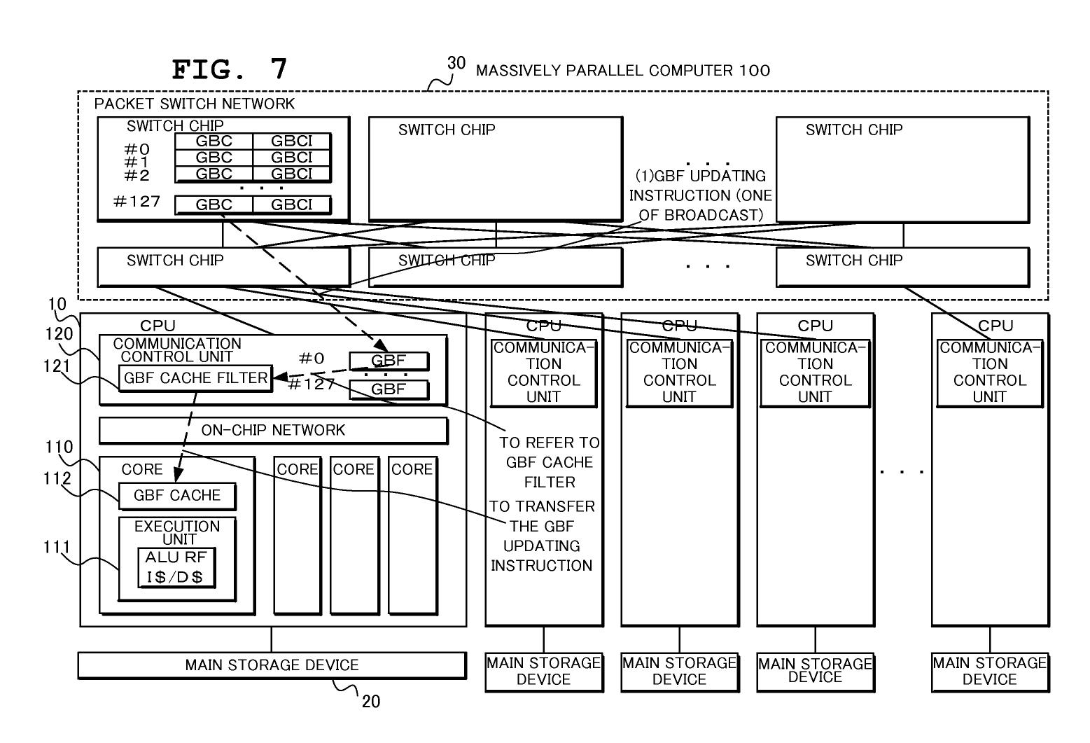

FIG. 7 shows outline of operation to be executed when synchronization is established.

When synchronization is established, first, GBC sends a GBF updating instruction to GBF on the communication control unit 120 of each CPU 10.

Next, the communication control unit 120 updates GBF related to the GBF updating instruction and at the same time refers to GBF cache filter 121 and when the GBF cache 112 corresponding to the GBF related to the GBF updating instruction exists in the computation core 110, transfers the GBF updating instruction to the computation core 110 related to the GBF cache 112.

When bits of the computation cores 1 and 3 are turned on in the relevant entry, for example, transfer the GBF updating instruction only to the computation cores 1 and 3.

When the GBF cache 112 receives the transferred updating instruction, the computation core 110, when caching the related GBC ID, turns on a valid bit while reflecting the updating instruction on the contents of the cache to turn on the valid bit.

If the GBF cache filter 121 has no entry, the GBF updating instruction is abandoned because it is not related to the GBF cache 112 on the computation core 110.

When referring to GBF, the computation core 110 first refers to the GBF cache 112 and only when the cache has no entry, executes reference to the main body of the GBF held in the communication control unit 120.

Barrier synchronization used in one program does not have so many kinds and it is known that reference to GBFs, for example, on the order of eight, is enough to fully draw performance of an application. In Patent Literature 4, for example, although only 8 to 16 barrier synchronization operations can be implemented in the entire system, it is recited to realize high enough performance.

### Description of Operation of the First Exemplary Embodiment

Next, operation of the massively parallel computer 100 according to the present exemplary embodiment will be detailed with reference to the drawings.

First, description will be made of a barrier synchronization control method on which the present invention is premised. First, execute the following processing to prepare for global barrier synchronization.

0-1: An application asks a system management process for use of GBC/GBCI to obtain right to use GBC/GBCI.

0-2: To the obtained GBCI and GBC, a representative process writes the number of processes to participate in barrier synchronization.

0-3: The computation core 110 reads and stores a value of GBF. Assume the read value to be A here.

Process participating in the synchronization implements synchronization by the following procedure.

1-1: Send a decrement instruction to GBC. When all the processes to participate in synchronization execute the decrement instruction, the value of GBC attains 0, so that establishment of synchronization is broadcast to update the value of GBF.

1-2: Read the value of GBF. Assume the value to be B.

1-3: If the values of A and B are the same, GBF will not be updated, so that synchronization fails to establish. In that case, return to 1-2.

1-4: If A and B are different values, synchronization establishes.

1-5: Substitute the value of B for A to execute subsequent processing.

The GBF cache 112 targets reduction of variation in delay of loop processing from 1-2 to 1-3. In the present invention, by providing the computation core 110 with a GBF cache in the communication control unit 120, reference latency is reduced.

The GBF cache 112 needs four operations.

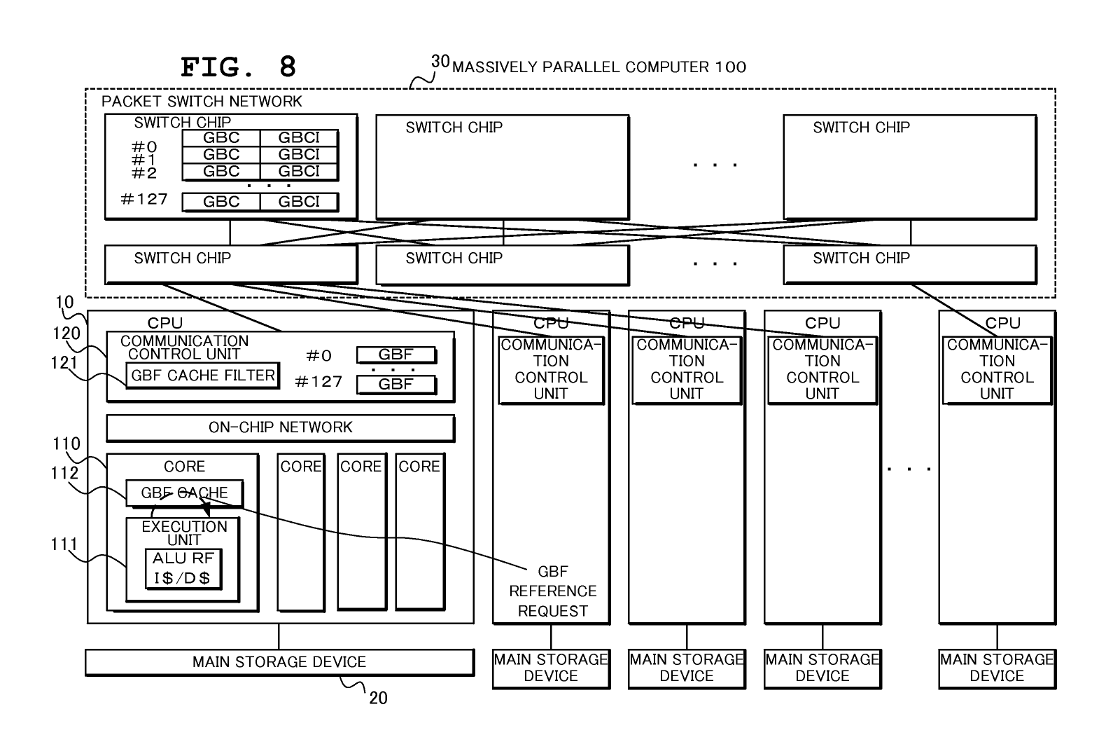

First is processing of a GBF reference request of the computation core 110 (FIG. 8).

Reference is activated by a GBF reference request from the computation core 110. When the computation core 110 issues a reference request, first refer to the GBF cache 112. If there exists an entry having an ID of a reference destination and its valid bit is 1, determination is made that the reference hits the cache. In this case, read the GBF value on the cache.

If there exists no entry having an ID of a reference destination or if its valid bit is 0, it is determined that the reference misses the cache. In this case, send the GBF reference request to the communication control unit 120 to ensure an entry for storing a reference destination GBF to refer to the main body of the GBF by a method which will be shown later.

Second is entry registration of the GBF cache 112 (FIG. 9).

Registration of an entry to the GBF cache 112 is executed when the reference to the GBF cache 112 has a cache miss. Upon detecting a cache miss, (1) ensure an entry for the GBF cache 112.

If an entry having an ID to be read already exists, use the entry and otherwise, check the reference information to select an entry to be evicted in order to ensure an entry for registration. Since an NRU policy on which the present invention is premised is a method well-known to those skilled in the art, no further description will be made.

When the entry to be evicted is determined, abandon information of the entry to register an ID of a GBF reference destination as a cause of the cache miss. At this time, no valid bit is set. In addition, at the time of cache miss, make the communication control unit 120 issue a GBF reference request without fail. Path of the request to the GBF passes through the GBF cache filter 121.

(2) At the time of registration of the GBF cache 112, similarly register an ID with the GBF cache filter 121 as well. If entry information evicted from the GBF cache filter 121 exists at the time of registration, update information of the entry will not be notified to the computation core 110 hereafter. In order to avoid such a situation, (3) in parallel with reading of GBF, notify a related computation core 110 of a flush instruction.

In view of consistency, when a GBF reference request sent to the communication control unit 120 is made, no reference to the GBF cache 112 is allowed until its replay is returned. If there exists an entry of the GBF cache 112 in which a valid bit establishes under such a condition, the computation core 110 interrupts execution of the instruction until a reply to a preceding GBF reference request is returned.

Third is updating of an entry of the GBF cache 112.

When updating GBF upon receiving a synchronization establishment instruction after GBC=0 is established or an update request from the computation core 110, send the update information to the computation core 110 which will cache the relevant GBF.

Since GBF information managed by each computation core 110 is written to the GBF cache filter 121 without fail, determine a sending destination based on the information and send the update information to the determined GBF cache 112.

When the update information arrives at the GBF cache 112 in the computation core 110, an updated value will be written to a relevant entry in the GBF cache 112. Simultaneously with the write, the valid bit is updated to 1. Valid bit only establishes in the GBF cache 112 at the timing of a notification of the update to the GBF cache 112. If the entry is already evicted in the registration of other GBF cache 112, the update information is abandoned.

Fourth is invalidation of an entry of the GBF cache 112.

The GBF cache 112 will be invalidated at the following timing.

4-1: When the computation core 110 executes write to an ID of GBF on the GBF cache 112, unlike an ordinary cache, for satisfying Partial Store Ordering, a value is written not on its GBF cache 112 but directly to its main body. At this time, change the valid bit of the GBF cache 112 to 0 in order to maintain coherence with the main body of the GBF. Unlike an ordinary cache, reducing a rate of write from the computation core 110 enables speed-up of updating in response to a GBF updating instruction from a network while maintaining coherence and consistency.

4-2: When an entry exists which is evicted from the GBF cache filter 121 on the communication control unit 120, following GBF cache 112 updating instructions will not arrive at the computation core 110, so that the cache will be cleared. When an entry to be evicted has ID=X and is registered with the computation cores 1 and 3, for example, send an instruction to invalidate the GBF cache 112 whose ID is X to the computation cores 1 and 3. When the GBF cache 112 receives the instruction to invalidate the GBF cache 112, change a valid bit of an entry having a coincident ID to 0.

4-3: When some failure or another is detected, invalidate all the entries of the GBF cache 112.

The GBF cache 112 invalidation instruction is notified by using the same path as that of the GBF cache 112 updating instruction.

### Effect of the First Exemplary Embodiment

The present exemplary embodiment is characterized in that in a mechanism for synchronization between CPUs of a massively parallel computer (super computer), variation in monitoring of a global barrier synchronous flag is reduced by the use of a global barrier synchronous flag cache, thereby reducing delay time in execution related to CPU synchronization. As a result, such effect as described in the following can be attained.

First effect is enabling reduction in reference delay because the computation core 110 need not issue a GBF reference request to the communication control unit 120.

Second effect is enabling execution of GBF reference processing without being affected by arbitration occurring between the computation core 110 and the communication control unit 120 because the computation core 110 need not send a GBF reference request to the communication control unit 120 to be shared by a plurality of the computation cores 110.

Third effect is achieving the above-described effects without requiring complicated procedure of copying by software by the caching of only a few of GBFs existing in numbers in the system by the computation core 110.

Fourth effect is that because even when an absolute distance between the computation core 110 and GBF is long, delay can be reduced by the reference to a cache, GBF originally located in the same CPU 10 can be located outside the CPU 10 as will be shown later with respect to a second exemplary embodiment, thereby allowing the system to be more freely set up.

Fifth effect is that with respect to reference to a global barrier synchronous flag, a global barrier synchronous flag reference time of referring to the GBF cache 112 existing in the computation core 110 is reduced without referring to the entity in the network away from the computation core 110, thereby mitigating reduction in performance caused by variation related to global barrier synchronous flag reference.

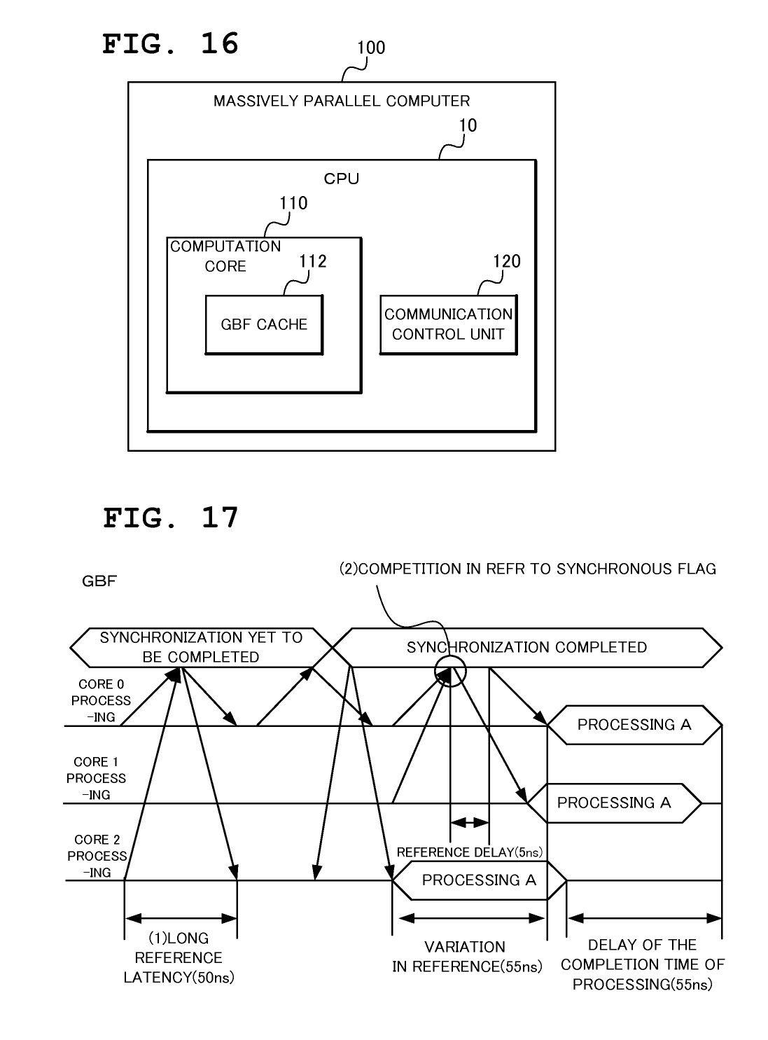

The synchronization control mechanism of the present invention is here shown in FIG. 15, from which it can be seen that competition and reference delay are both improved by the provision of a GBF cache in each computation core and that assuming the reference delay to be 5 ns, variation in reference is reduced to 5 ns. As a result, a time required for completing the processing A can be shorter by 50 ns than in the case using the background art shown in FIG. 16. Since delay of one-way communication is in general several micro seconds, performance improvement on the order of 5% is expected by the application of the present invention.

Minimum structure which can solve the problem of the present invention is shown in FIG. 16. The massively parallel computer 100 includes a plurality of CPUs 10 to implement barrier synchronization by using a global barrier synchronous counter, in which the CPU 10 includes the computation core 110 including the GBF cache 112 which caches a part of a plurality of global barrier synchronous flags for executing synchronization control between the CPUs, and the communication control unit 120 including a global barrier synchronous flag, in which the computation core 110, when issuing a global barrier synchronous flag reference request, first refers to the GBF cache 112 and only when the reference has a cache miss, issues a global barrier synchronous flag reference request to the communication control unit 120, thereby solving the above-described problems of the present invention.

### Second Exemplary Embodiment

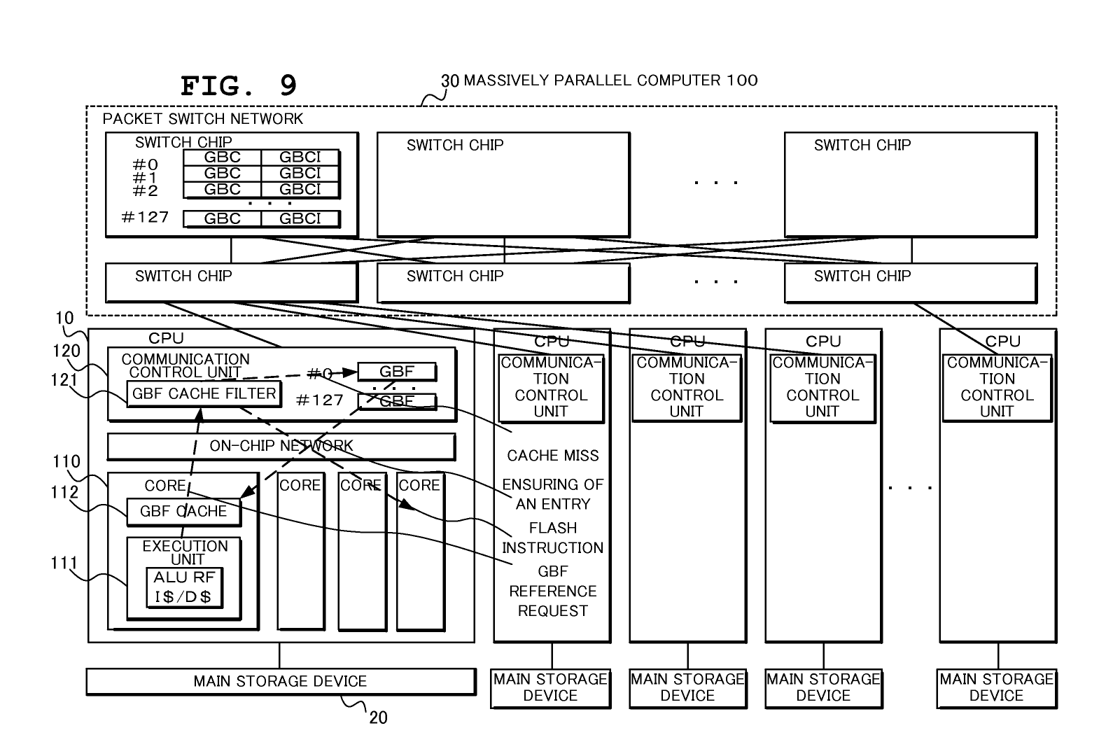

Next, a second exemplary embodiment of the present invention will be described with reference to FIG. 10.

FIG. 10 shows an example where GBF is held in the network.

When referring to GBF repeatedly, the reference will hit the GBF cache 112 without fail, so that even when data of a cache which caches GBF is located at a greater distance from the computation core 110, effective latency will not be affected.

### Third Exemplary Embodiment

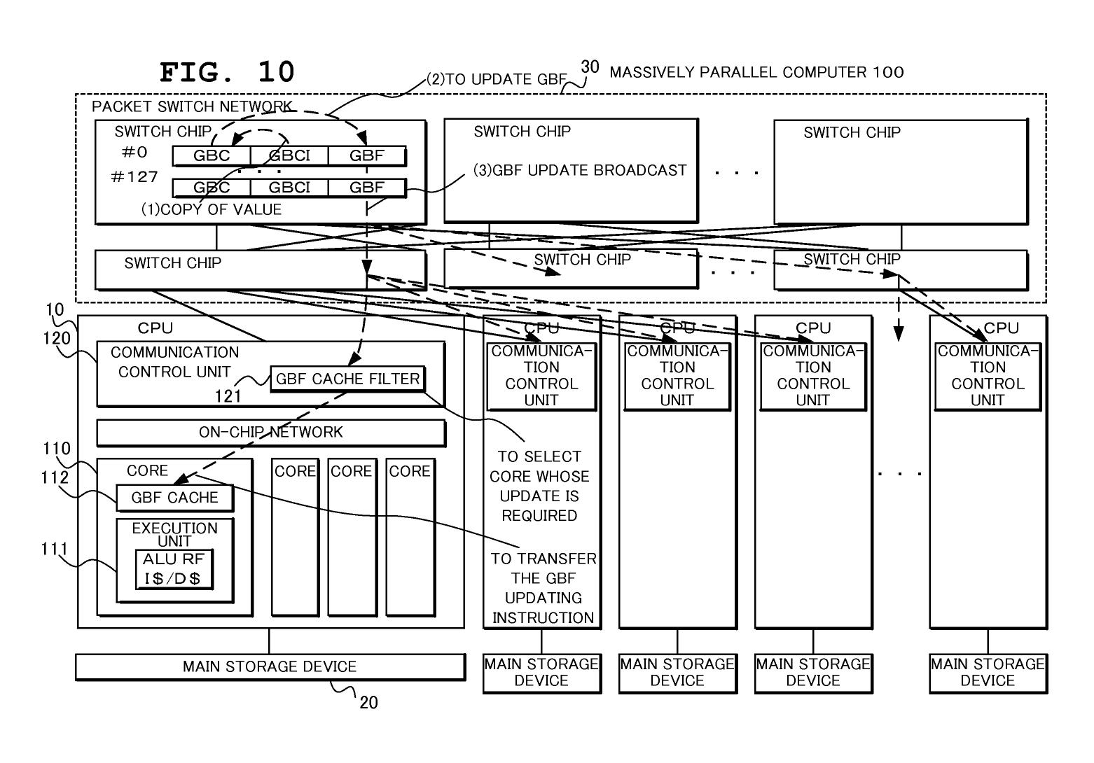

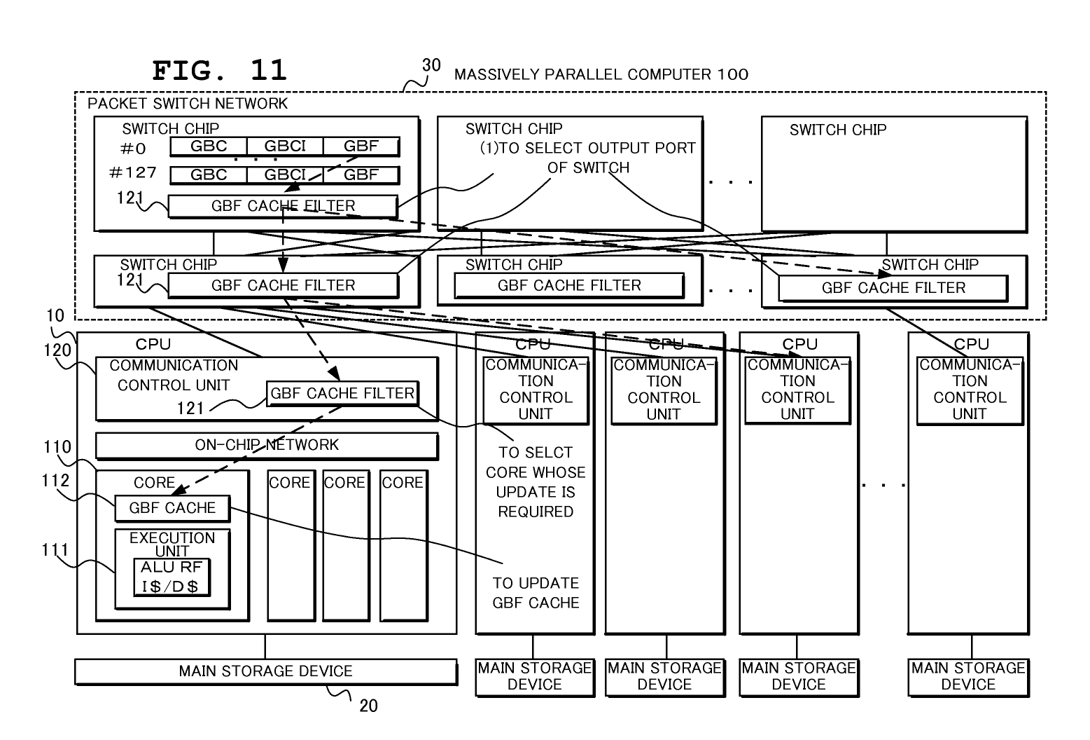

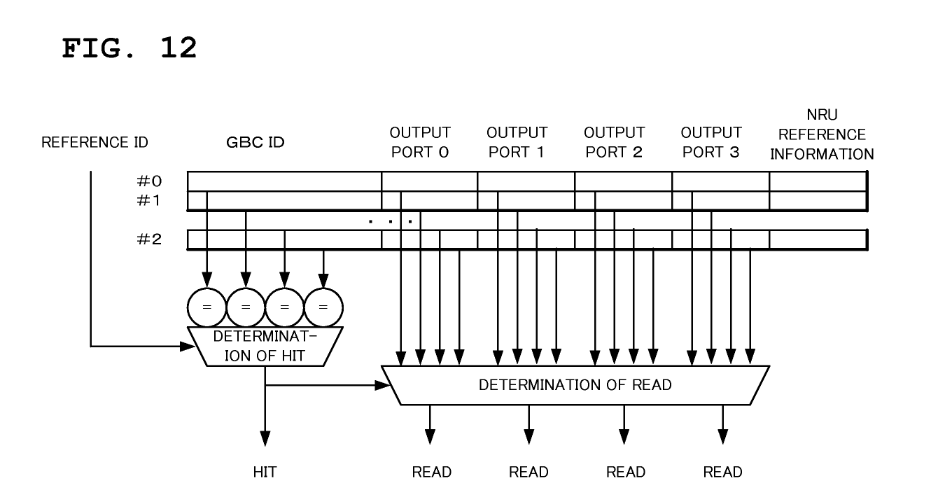

Next, a third exemplary embodiment of the present invention will be described with reference to FIG. 11 and FIG. 12.

FIG. 11 shows an example where GBF is held in the network and the GBF cache filter 121 is held in the network as well. Structure thereof is shown in FIG. 12.

The GBF cache filter 112 on the switch chip stores not the number of the computation core 110 but which output port should be notified of GBF update.

When a port 0 and a port 3 store 1, for example, broadcast a GBF updating notification to the port 0 and the port 3.

When the entry of the GBF cache 112 is evicted, send an invalidation notification to a related port.

When the entry of the GBF cache 112 receives the invalidation notification, similarly to a case of its eviction, send an instruction to invalidate the GBF cache 112 to clear port information of the relevant entry.

According to the present exemplary embodiment, since a broadcast destination can be limited by the GBF cache filter 121, traffic of a packet switch network on a massively parallel computer can be reduced.

### Fourth Exemplary Embodiment

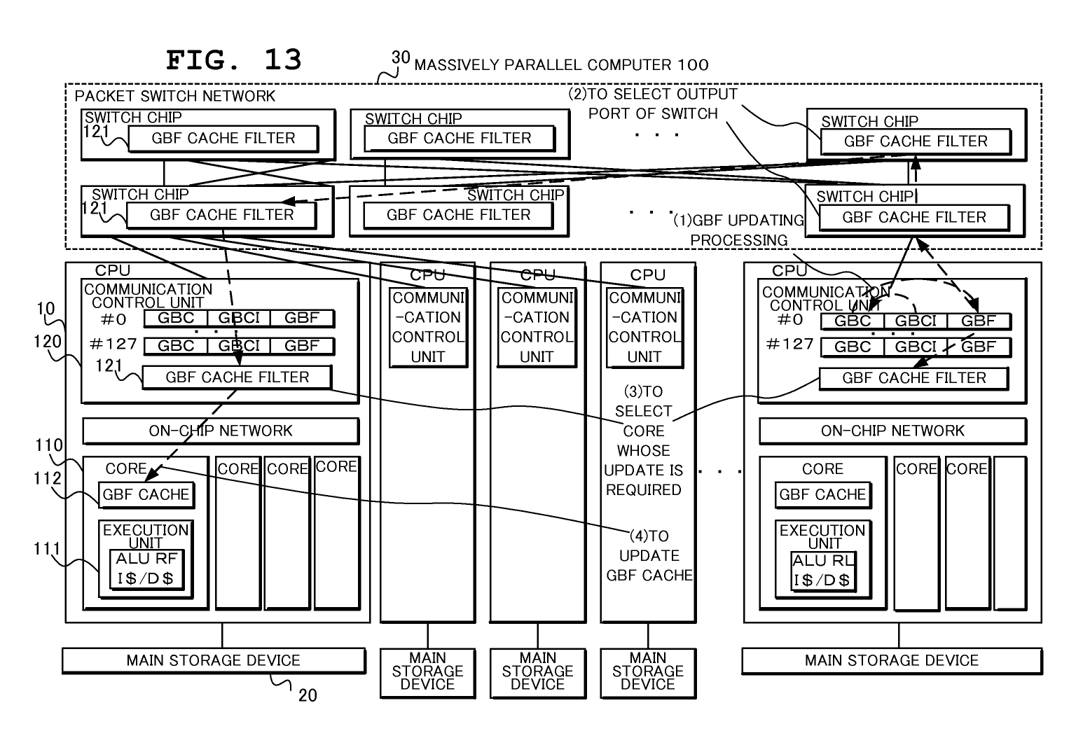

Next, a four exemplary embodiment of the present invention will be described with reference to FIG. 13.

FIG. 13 shows an example where GBC/GBCl/GBCF in the packet switch network according to the second exemplary embodiment is shifted to the communication control unit 120 of each CPU 10.

Massively parallel computer does not always set up one system as a whole but it is in general applicable as numbers of small-scale systems in some cases. In such a case, if only a fixed number (e.g. 128) of GBC exist on the system, a synchronization mechanism using GBC cannot be used when executing more than 128 parallel jobs.

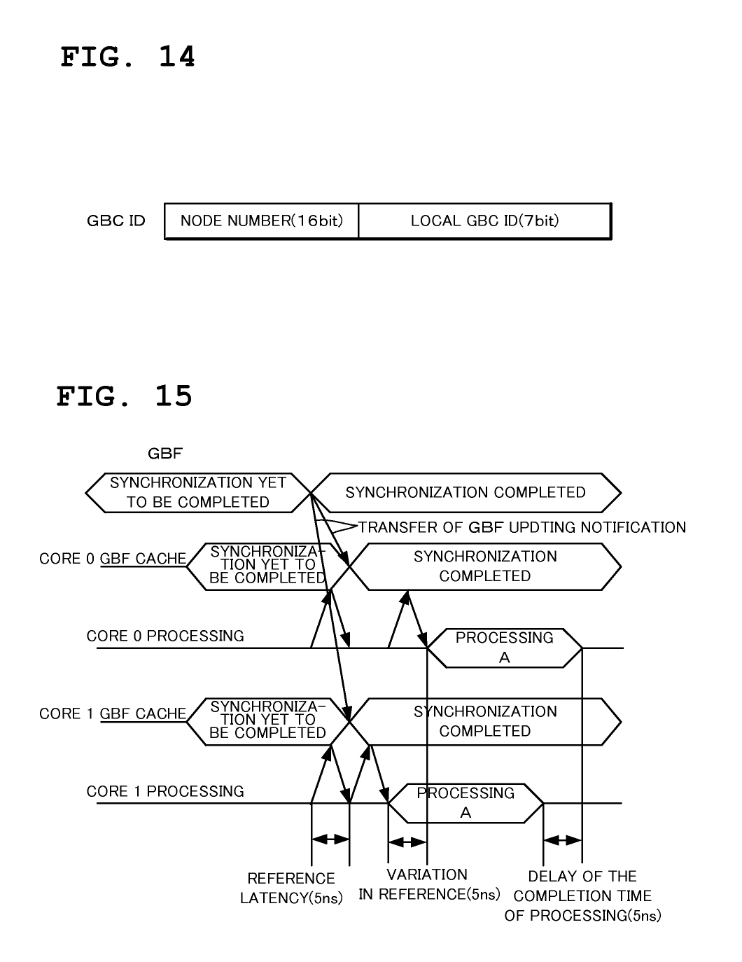

By disposing GBC/GBCF in each CPU 10 to increase the number of CPUs in the system as well as the number of GBCs/GBFs, more flexible system operation is enabled. In this case, assignment of GBC IDs is executed such that a higher-order bit of ID is assigned to the CPU number and a lower-order bit to GBC ID in the CPU (FIG. 14).

As the GBF cache filter 121 in the switch chip, the one shown in FIG. 12 can be used.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

An arbitrary combination of the foregoing components and conversion of representation of the present invention among a method, a device, a system, a recording medium, a computer program and the like are also valid as a mode of the present invention.

The respective components of the present invention need not exist independently, and the plurality of the components may be formed as one member, one component may be formed of a plurality of members, a certain component may be a part of other component, a part of a certain component and a part of other component may overlap with each other, or the like.

In addition, although the method and the computer program of the present invention have a plurality of procedures recited in order, the order of recitation does not limit the order of execution of the plurality of procedures. Accordingly, when executing the method and the computer program of the present invention, the order of the plurality of procedures can be changed within the range not hindering the contents.

Moreover, execution of the plurality of procedures of the method and the computer program of the present invention is not limited to execution at different timing with each other. Therefore, during execution of a certain procedure, other procedure might occur, a part or all of execution timing of a certain procedure and execution timing of other procedure might overlap with each other, or the like.

Furthermore, although a part or all of the above-described exemplary embodiments can be recited also as claims to follow, they are not limited to the same.

The whole or part of the exemplary embodiments disclosed above can be described as, but not limited to, the following supplementary notes.

(Supplementary note 1) A massively parallel computer including a plurality of CPUs to implement barrier synchronization by using a global barrier synchronous counter, wherein said CPUs each comprising:

a computation core including a GBF cache which caches a part of a plurality of global barrier synchronous flags for controlling synchronization between the CPUs; and

a communication control unit including the global barrier synchronous flag,

when making a request for reference to said global barrier synchronous flag, said computation core first referring to said GBF cache and only when the reference has a cache miss, making a request to said communication control unit to refer to the global barrier synchronous flag.

(Supplementary note 2) The massively parallel computer according to supplementary note 1, wherein said communication control unit includes a GBF cache filter which stores information about which of said computation cores holds a cache of which of said global barrier synchronous flags, and

said communication control unit, when updating said global barrier synchronous flag, refers to said GBF cache filter to notify update information to said computation core having a cache of the global barrier synchronous flag.

(Supplementary note 3) The massively parallel computer according to supplementary note 1 or supplementary note 2, wherein with respect to said global barrier synchronous flag, said GBF cache registers an entry including a valid bit, an identifier which uniquely identifies said global barrier synchronous flag, and a value of said global barrier synchronous flag.

(Supplementary note 4) The massively parallel computer according to supplementary note 3, wherein said computation core updates a value of said global barrier synchronous flag, as well as validating said valid bit of the entry based on said update information.

(Supplementary note 5) The massively parallel computer according to supplementary note 3 or supplementary note 4, wherein said computation core, when referring to said GBF cache, if there exists said entry having said identifier to be read and said valid bit is valid, determines that the entry has a cache hit, and when there fails to exist said entry having said identifier to be read, or when said entry having said identifier to be read exists but the valid bit is invalid, determines that the entry has a cache miss.

(Supplementary note 6) The massively parallel computer according to supplementary note 5, wherein said computation core,

when reference to said GBF cache has a cache miss, ensures, in said GBF cache, an entry for registering a global barrier synchronous flag having a cache miss, and

registers, at the entry, said global barrier synchronous flag having a cache miss which is obtained in response to a request for reference to said global barrier synchronous flag.

(Supplementary note 7) The massively parallel computer according to supplementary note 6, wherein said entry includes reference information for replacing an entry, and

said computation core ensures an entry for registering a global barrier synchronous flag having a cache miss by, when there exists a global barrier synchronous flag to be referred to, assuming the entry as an entry for registering a global barrier synchronous flag having a cache miss, and when there exists no global barrier synchronous flag, determining an entry to be abandoned based on said reference information to abandon the entry.

(Supplementary note 8) The massively parallel computer according to supplementary note 6 or supplementary note 7, wherein said computation core registers, at said entry ensured for registering a global barrier synchronous flag having a cache miss, said identifier to be read and invalidates said valid bit, as well as making a request to said communication control unit for referring to the global barrier synchronous flag.

(Supplementary note 9) The massively parallel computer according to any one of supplementary note 6 through supplementary note 8, wherein said communication control unit updates information of said GBF cache filter when a global barrier synchronous flag having a cache miss is registered at said GBF cache.

(Supplementary note 10) The massively parallel computer according to any one of supplementary note 1 through supplementary note 9, wherein when making a request to said communication control unit for referring to a global barrier synchronous flag, said computation core inhibits reference to the GBF cache until the result of the reference is returned.

(Supplementary note 11) A synchronization method by a massively parallel computer including a plurality of CPUs to implement barrier synchronization by using a global barrier synchronous counter, which CPUs each including a computation core and a communication control unit, wherein

when making a request to the communication control unit including a global barrier synchronous flag for reference to the global barrier synchronous flag, said computation core executes a step of first referring to a GBF cache that said computation core includes and only when the reference has a cache miss, making a request to said communication control unit to refer to the global barrier synchronous flag, and

said GBF cache caches a part of a plurality of global barrier synchronous flags for controlling synchronization between said CPUs.

(Supplementary note 12) The synchronization method according to supplementary note 11, wherein

said communication control unit executes a step of, when updating said global barrier synchronous flag, referring to a GBF cache filter that the communication control unit includes to notify update information to said computation core having a cache of the global barrier synchronous flag, and

said GBF cache filter stores information about which of said computation cores holds a cache of which of said global barrier synchronous flags.

(Supplementary note 13) The synchronization method according to supplementary note 11 or supplementary note 12, wherein with respect to said global barrier synchronous flag, said GBF cache registers an entry including a valid bit, an identifier which uniquely identifies said global barrier synchronous flag, and a value of said global barrier synchronous flag.

(Supplementary note 14) The synchronization method according to supplementary note 13, wherein said computation core executes a step of updating a value of said global barrier synchronous flag, as well as validating said valid bit of the entry based on said update information.

(Supplementary note 15) The synchronization method according to supplementary note 13 or supplementary note 14, wherein said computation core executes a step of, when referring to said GBF cache, if there exists said entry having said identifier to be read and said valid bit is valid, determining that the entry has a cache hit, and when there fails to exist said entry having said identifier to be read, or when said entry having said identifier to be read exists but the valid bit is invalid, determining that the entry has a cache miss.

(Supplementary note 16) The synchronization method according to supplementary note 15, wherein said computation core executes the steps of:

when reference to said GBF cache has a cache miss, ensuring, in said GBF cache, an entry for registering a global barrier synchronous flag having a cache miss, and

registering, at the entry, said global barrier synchronous flag having a cache miss which is obtained in response to a request for reference to said global barrier synchronous flag.

(Supplementary note 17) The synchronization method according to supplementary note 16, wherein

said computation core executes a step of, when there exists a global barrier synchronous flag to be referred to, assuming the entry as an entry for registering a global barrier synchronous flag having a cache miss, and when there exists no global barrier synchronous flag, determining an entry to be abandoned based on reference information for replacing an entry that said entry includes to abandon the entry, thereby ensuring an entry for registering a global barrier synchronous flag having a cache miss.

(Supplementary note 18) The synchronization method according to supplementary note 16 or supplementary note 17, wherein said computation core executes a step of registering, at said entry ensured for registering a global barrier synchronous flag having a cache miss, said identifier to be read and invalidating said valid bit, as well as making a request to said communication control unit for referring to the global barrier synchronous flag.

(Supplementary note 19) The synchronization method according to any one of supplementary note 16 through supplementary note 18, wherein said communication control unit executes a step of updating information of said GBF cache filter when a global barrier synchronous flag having a cache miss is registered at said GBF cache.

(Supplementary note 20) The synchronization method according to any one of supplementary note 11 through supplementary note 19, wherein said computation core executes a step of, when making a request to said communication control unit for referring to a global barrier synchronous flag, inhibiting reference to the GBF cache until the result of the reference is returned.

(Supplementary note 21) A computer-readable medium storing a synchronization program operable on a computer forming a massively parallel computer including a plurality of CPUs to implement barrier synchronization by using a global barrier synchronous counter, said CPUs each including a computation core and a communication control unit, wherein said synchronization program executes the following processing of:

causing said computation core to execute a processing of, when making a request to the communication control unit including a global barrier synchronous flag for reference to the global barrier synchronous flag, first referring to said GBF cache that said computation core includes and only when the reference has a cache miss, making a request to said communication control unit to refer to the global barrier synchronous flag; and

caching a part of a plurality of global barrier synchronous flags for controlling synchronization between the CPUs to a GBF cache that said computation core has.

(Supplementary note 22) The computer-readable medium according to supplementary note 21, wherein said synchronization program causes

said communication control unit to execute a processing of, when updating said global barrier synchronous flag, referring to a GBF cache filter that the communication control unit includes to notify update information to said computation core having a cache of the global barrier synchronous flag, and wherein

said GBF cache filter stores information about which of said computation cores holds a cache of which of said global barrier synchronous flags.

(Supplementary note 23) The computer-readable medium according to supplementary note 21 or supplementary note 22, wherein with respect to said global barrier synchronous flag, said GBF cache registers an entry including a valid bit, an identifier which uniquely identifies said global barrier synchronous flag, and a value of said global barrier synchronous flag.

(Supplementary note 24) The computer-readable medium according to supplementary note 23, wherein said synchronization program causes said computation core to execute a processing of updating a value of said global barrier synchronous flag, as well as validating said valid bit of the entry based on said update information.

(Supplementary note 25) The computer-readable medium according to supplementary note 23 or supplementary note 24, wherein said synchronization program causes said computation core to execute a processing of, when referring to said GBF cache, if there exists said entry having said identifier to be read and said valid bit is valid, determining that the entry has a cache hit, and when there fails to exist said entry having said identifier to be read, or when said entry having said identifier to be read exists but the valid bit is invalid, determining that the entry has a cache miss.

(Supplementary note 26) The computer-readable medium according to supplementary note 25, wherein said synchronization program causes said computation core to execute the processing of:

when reference to said GBF cache has a cache miss, ensuring, in said GBF cache, an entry for registering a global barrier synchronous flag having a cache miss, and

registering, at the entry, said global barrier synchronous flag having a cache miss which is obtained in response to a request for reference to said global barrier synchronous flag.

(Supplementary note 27) The computer-readable medium according to supplementary note 26, wherein said synchronization program causes said computation core to execute a processing of, when there exists a global barrier synchronous flag to be referred to, assuming the entry as an entry for registering a global barrier synchronous flag having a cache miss, and when there exists no global barrier synchronous flag, determining an entry to be abandoned based on reference information for replacing an entry that said entry includes to abandon the entry, thereby ensuring an entry for registering a global barrier synchronous flag having a cache miss.

(Supplementary note 28) The computer-readable medium according to supplementary note 26 or supplementary note 27, wherein said synchronization program causes said computation core to execute a processing of registering, at said entry ensured for registering a global barrier synchronous flag having a cache miss, said identifier to be read and invalidating said valid bit, as well as making a request to said communication control unit for referring to the global barrier synchronous flag.

(Supplementary note 29) The computer-readable medium according to any one of supplementary note 26 through supplementary note 28, wherein said synchronization program causes said communication control unit to execute a processing of updating information of said GBF cache filter when a global barrier synchronous flag having a cache miss is registered at said GBF cache.

(Supplementary note 30) The computer-readable medium according to any one of supplementary note 21 through supplementary note 29, wherein said synchronization program causes said computation core to execute a processing of, when making a request to said communication control unit for referring to a global barrier synchronous flag, inhibiting reference to the GBF cache until the result of the reference is returned.

### INCORPORATION BY REFERENCE

This application is based upon and claims the benefit of priority from Japanese patent application No. 2012-037566, filed on Feb. 23, 2012, the disclosure of which is incorporated herein in its entirety by reference.

What is claimed is:

1. A massively parallel computer including a plurality of CPUs to implement barrier synchronization by using a global barrier synchronous counter, wherein said CPUs each comprising:
a computation core including a GBF cache which caches a part of a plurality of global barrier synchronous flags for controlling synchronization between the CPUs; and
a communication control unit including the global barrier synchronous flag,
when making a request for reference to said global barrier synchronous flag, said computation core first referring to said GBF cache and only when the reference has a cache miss, making a request to said communication control unit to refer to the global barrier synchronous flag.

2. The massively parallel computer according to claim 1, wherein said communication control unit includes a GBF cache filter which stores information about which of said computation cores holds a cache of which of said global barrier synchronous flags, and
said communication control unit, when updating said global barrier synchronous flag, refers to said GBF cache filter to notify update information to said computation core having a cache of the global barrier synchronous flag.

3. The massively parallel computer according to claim 1, wherein with respect to said global barrier synchronous flag, said GBF cache registers an entry including a valid bit, an identifier which uniquely identifies said global barrier synchronous flag, and a value of said global barrier synchronous flag.

4. The massively parallel computer according to claim 3, wherein said computation core updates a value of said global barrier synchronous flag, as well as validating said valid bit of the entry based on said update information.

5. The massively parallel computer according to claim 3, wherein said computation core, when referring to said GBF cache, if there exists said entry having said identifier to be read and said valid bit is valid, determines that the entry has a cache hit, and when there fails to exist said entry having said identifier to be read, or when said entry having said identifier to be read exists but the valid bit is invalid, determines that the entry has a cache miss.

6. The massively parallel computer according to claim 5, wherein said computation core,
when reference to said GBF cache has a cache miss, ensures, in said GBF cache, an entry for registering a global barrier synchronous flag having a cache miss, and
registers, at the entry, said global barrier synchronous flag having a cache miss which is obtained in response to a request for reference to said global barrier synchronous flag.

7. The massively parallel computer according to claim 6, wherein said entry includes reference information for replacing an entry, and
said computation core ensures an entry for registering a global barrier synchronous flag having a cache miss by, when there exists a global barrier synchronous flag to be referred to, assuming the entry as an entry for registering a global barrier synchronous flag having a cache miss, and when there exists no global barrier synchronous flag, determining an entry to be abandoned based on said reference information to abandon the entry.

8. The massively parallel computer according to claim 6, wherein said computation core registers, at said entry ensured for registering a global barrier synchronous flag having a cache miss, said identifier to be read and invalidates said valid bit, as well as making a request to said communication control unit for referring to the global barrier synchronous flag.

9. A synchronization method by a massively parallel computer including a plurality of CPUs to implement barrier synchronization by using a global barrier synchronous counter, which CPUs each including a computation core and a communication control unit, wherein
when making a request to the communication control unit including a global barrier synchronous flag for reference to the global barrier synchronous flag, said computation core executes a step of first referring to a GBF cache that said computation core includes and only when the reference has a cache miss, making a request to said communication control unit to refer to the global barrier synchronous flag, and
said GBF cache caches a part of a plurality of global barrier synchronous flags for controlling synchronization between said CPUs.

10. A computer-readable medium storing a synchronization program operable on a computer forming a massively parallel computer including a plurality of CPUs to implement barrier synchronization by using a global barrier synchronous counter, said CPUs each including a computation core and a communication control unit, wherein said synchronization program executes the following processing of:
causing said computation core to execute a processing of, when making a request to the communication control unit including a global barrier synchronous flag for reference to the global barrier synchronous flag, first referring to said GBF cache that said computation core includes and only when the reference has a cache miss, making a request to said communication control unit to refer to the global barrier synchronous flag; and
caching a part of a plurality of global barrier synchronous flags for controlling synchronization between the CPUs to a GBF cache that said computation core has.
